(19) United States
(12) Patent Application Publication
(10) Pub. No.: US 2013/0307287 A1
(43) Pub. Date: Nov. 21, 2013

(54) TONNEAU COVER LOCKING CLAMPING METHOD AND APPARATUS

(71) Applicants: Shi Hang, Changzhou City (CN); Zheng Hongjuan, Changzhou City (CN)

(72) Inventors: Shi Hang, Changzhou City (CN); Zheng Hongjuan, Changzhou City (CN)

(21) Appl. No.: 13/474,549

(22) Filed: May 17, 2012

(51) Int. Cl. B60P 7/02

(52) U.S. Cl. 296/100.01

(57) ABSTRACT

According to the principles of the present invention, a tonneau system for a cargo box provides a folding handle and a method to lock in place tensioning of the clamping system to the cargo bed of a vehicle. This clamping method is incorporated as part of a sub support frame and fore which clamps are used to align and mount the cover to the cargo bed.

### BACKGROUND OF THE INVENTION

1. Field of the Invention

The present invention in general relates to truck cargo bed covers and more particularly to a clamping method for secure coupling of a cover to the cargo bed.

2. Background and Related Art

Tonneau covers have been used for a number of years to cover the cargo box of pickup trucks and protect its interior against dirt, debris and other environmental contaminants and in some cases to improve the aesthetic quality thereof. Originally tonneau covers were designed by upholstery shops and typically made of vinyl covered fabrics or canvas. The material was often doubled over along its edges for added strength and appearance. Male snaps were then attached to the sides of the cargo box via fasteners, while female snaps were attached along the edges of the cover. Wooden bows were sometimes used to span the cargo box and ensure that the cover remained high enough to drain water. Unfortunately these covers were sometimes difficult to handle, often led to corrosion around the snaps and occasionally failed to protect the cargo box.

Over the years a wide variety of covers designs have been developed, in general these covers are known as either “caps” or “tonneau covers.” Caps are typically an enclosure that extends substantially above the bed so as to increase the height of the cargo bed while a tonneau cover typically lies substantially flush with the top walls of the cargo bed without significantly increasing the height of the cargo bed.

Most tonneau cover systems today are clamp releasable from the cargo bed since it can be necessary on occasion to carry loads in the bed that exceed height limitations of the cover.

Therefore tonneau mounting systems have evolved over the last 30 years and where now most produced incorporate internal framing which provide attachment of either a hard or soft cover to an internal frame work. This frame work typically provides a method for mounting or securing the cover to the cargo bed. Most of these methods include clamping systems which are designed to couple up to the sidewalls of the cargo bed. One such clamping system used allows a clamp that “bottomed out” to prevent over stressing of the sidewalls of the cargo bed. Examples of these clamping systems can be seen in U.S. Pat. Nos. 4,730,866 and 4,838,602 issued to Nett.

Many of these previous features were also incorporated in later designs with slight modifications. For example, U.S. Pat. No. 5,076,338, similar to U.S. Pat. No. 4,036,521 employed a pivoting rail to retain tightness of the tonneau cover material. In this particular system, an “L” shaped rail, which presumably puts the pivot lower for added mechanical advantage was used to tighten the tonneau cover material from a fore and aft position rather than cross-car position. This system further employed 45 degree angled frame rails and Velcro was used as the fastener. The frame rails are coupled to the sidewalls of the cargo box using a plurality of C-clamps.

In more recent designs, a rotating rear rail was provided that included positioning the pivot near the upper surface of the tonneau to minimize torque exerted on, the rear rail. The lower torque of this system permitted the use of relatively lightweight plastic levers to lock the rear rail and prevent it from rotating. The combination of the length of theses plastic levers and high pivot locations enabled the loads exerted on the levers to be about 1/12^{th} that of the tonneau cover material. Springs were also used which enabled the automatic tensioning of the tonneau cover material. An example of this system can be seen in U.S. Pat. No. 5,251,951, issued to Wheatley. This disclosure of which is hereby incorporated and made a part of this application by reference.

Relatively recently, a tonneau cover system having a screw adjustment mechanism was developed for permitting the fore and aft adjustment of the front rail. This screw adjustment mechanism serves to tighten the tonneau cover material in response to wear and to stretch that is common in tonneau cover systems. The tonneau cover system further employed the “L” shaped lever and lower-positioned pivot which requires the lever to carry an enormous amount of force. Consequently a stronger latch is required to overcome these loading forces and minimize wear and breakage. Frame rails coupled to the sidewalls of the cargo box using a plurality of clamps can be seen in U.S. Pat. No. 5,906,407 issued to Schmeichels. This disclosure of which is hereby incorporated and made a part of this application by reference.

A TRUXEDO cover which is not believed to be patented made by SHURCO includes a rotating, rectangular, rear rail having a rounded front pivot, vertical sides with VELCRO attachment and spring pins that push on a front rail mounted inboard of the side rails. These spring pins push against the front rail to tension the system in the fore, aft-direction. The spring pins which are attached to the side rails via brackets may not firmly engage the front rail due to their inboard location which may cause the brackets to come out of alignment as the side rails rotate. Additionally the rounded shape of the front rails may cause the push pins to slip off-center.

U.S. Pat. No. 6,293,608 issued to Dicke, discloses a tailgate rail interconnected to side rails with an interconnecting plate coupled to the side rails and slide able coupled to the corner piece for accommodating relative movement there between. A biasing device being a coil spring is further provided thus to provides tensioning to the tonneau fabric.

U.S. Pat. No. 6,893,073 issued to Wheatley, discloses an adjustable clamping system coupled to the side wall of the cargo bed and having interlocking connection via an adjustable bracket to the side rails of a tonneau frame. This disclosure of which is hereby incorporated and made part of this application by reference.

U.S. Pat. No. 7,334,830 issued to Weldy, discloses a sectional tonneau cover having vertically suspended cam locks and having side to side adjustability provided for by slots in the frame. This disclosure of which is hereby incorporated and made part of this application by reference.

Many uncoupling issues occur when stowed cargo sometime shifts within the cargo bed and impacts a vertical hanging clamp as the design referenced in U.S. Pat. No. 7,334,830 issued to Weldy and U.S. Pat. No. 6,893,073 issued to Wheatley, both disclose an adjustable clamping system coupled to the side wall of the cargo bed and having interlocking connection via an adjustable bracket to the side rails of a tonneau frame.

If during cargo loading or when traveling stowed Cargo should shift and impact one or more of the vertical hanging clamp mechanism, secure retention of the cover to the cargo bed can be jeopardized. The aerodynamics of the cab and cargo bed of a traveling vehicle once exceeding speeds over 30 mph create both downward and upward pressures at the same time but at different points on the cover. These unequal pressure points result in lesser tensioning of the clamping mechanism. This can be duly noted in observation of some types of freeway debris where lifting forces allow cross winds to enter under sectional portions of a cover and resulting in the uncoupling of the cover from the cargo bed.

### SUMMARY OF THE INVENTION

According to the principles of the present invention, a tonneau system for a cargo box provides a foldable handle, lock in place clamping system incorporated as part of a sub support frame and where clamps are used to align and mount the cover to the cargo bed. The support frame includes side rails having an inboard section and an a outboard section such that the outboard section is positioned adjacent to the top surface of the sidewall of the cargo box so as to aid in the supporting and positioning of the tonneau cover's support frame. A series of locking clamps capable of suspension from the support frame include a pair of members being positional in any one of a plurality of discrete positions and providing adjustment mechanisms to permit selective locking tension of a cover support frame to the cargo bed.

However uncoupling measures for which protection is not provided for by current manufactures now allows a cover to cargo bed coupling retention clamp in which its handle is protected from loading or shifting cargo when folded up in parallel with the clamping mechanism and once folded, locked into place. A retaining safety pin is placed into the clamp to insure proper tensioning of the cover to the cargo bed. The retention clamp is readily adaptable to a variety of tonneau cover frame configurations and can be pre-assembled prior to installation and readily aligns and attaches as a complete cover assembly to a variety of different model pick-up trucks and, when utilized, provides common latching mechanism allowing a secure lockable enclosure for the cargo bed.

Other objects, advantages and novel features of the present invention will become readily apparent from the following drawings and detailed description of preferred embodiments.

### BRIEF DESCRIPTION OF THE DRAWINGS

FIG. 1 illustrates the top view of a pick up truck cargo bed.

FIG. 2 illustrates an internal structural cut away view of typical cargo bed construction having a formed support lip which can be used as a clamp connection and tensioning point.

FIG. 3 illustrates the clamping system.

FIG. 4 illustrates the tonneau cover system.

### DESCRIPTION OF THE PREFERRED EMBODIMENTS

The following description of the preferred embodiments is merely exemplary in nature and is in no way intended to limit the invention, its application, or uses.

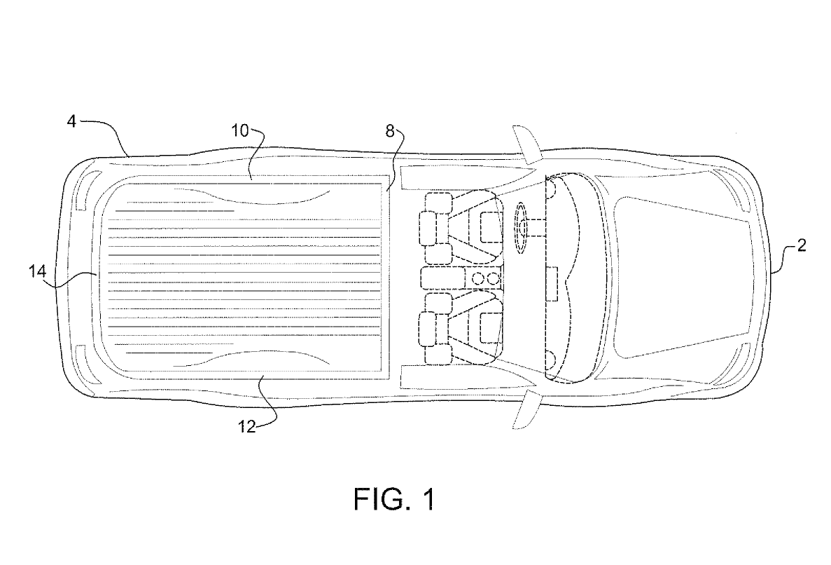

In reference to FIG. 1, a pickup truck 2 is shown having a cargo bed 4 consisting of a front wall 10, a left side wall 12, a right side wall 14 and a tail gate or rear wall 16. These connecting side walls, 10, 12, 14, and 16 typically provide surface for supporting bracketing which is in accordance with the present invention. It should be further understood that corresponding left side wall 12 and right side wall 14 are built identical and are best seen in FIG. 1 having a general horizontal top surface and downward extending inside walls. It should be appreciated that many numbers of side wall configurations exist which are dependent upon styling and functionality determined by the vehicle manufacture. Hence, it should be understood that the particular shape of these surface/walls may vary along with the specific shape of those corresponding components such as cargo wall supporting brackets or frame rails which mates to the tonneau framing required for mounting the cover to the cargo box.

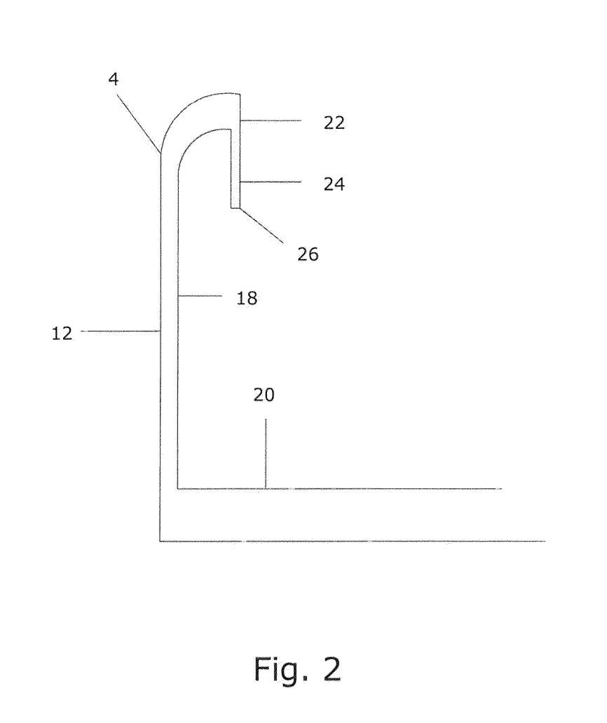

In reference to FIG. 2, most cargo beds 4 are structured to increase cargo bed strength by including both an inter wall 18 and outer wall 12, the inter wall 18 protects the outer wall 12 from damage caused by cargo loading or shifting. Both inner and outer walls connect to floor 20 which provides support for cargo bed walls 10, 12, 14 and 16. At the point where inter wall 18 mates to outer wall 12, a downward lip 22 is formed providing additional strength to wall sections, 12 and 18. Downward lip 22 provides a side wall 24 which can be utilized as a mounting point for supporting tonneau frame bracketing or the lower edge of the lip 26 can be used as a direct connection point for a clamping system incorporating an inverted lip receiving slot. A tonneau cover internal longitudinal frame work consists of a front rail, left rail, right rail and a rear rail. Cross support sub rails connect from left to right and can be hinged to form sections which open or be removed and further, the sub rails provide support for tonneau covering. Inter tonneau cover frame work is designed and constructed in mirrored symmetry to the cargo bed walls in which pertains to a particular vehicle make and model.

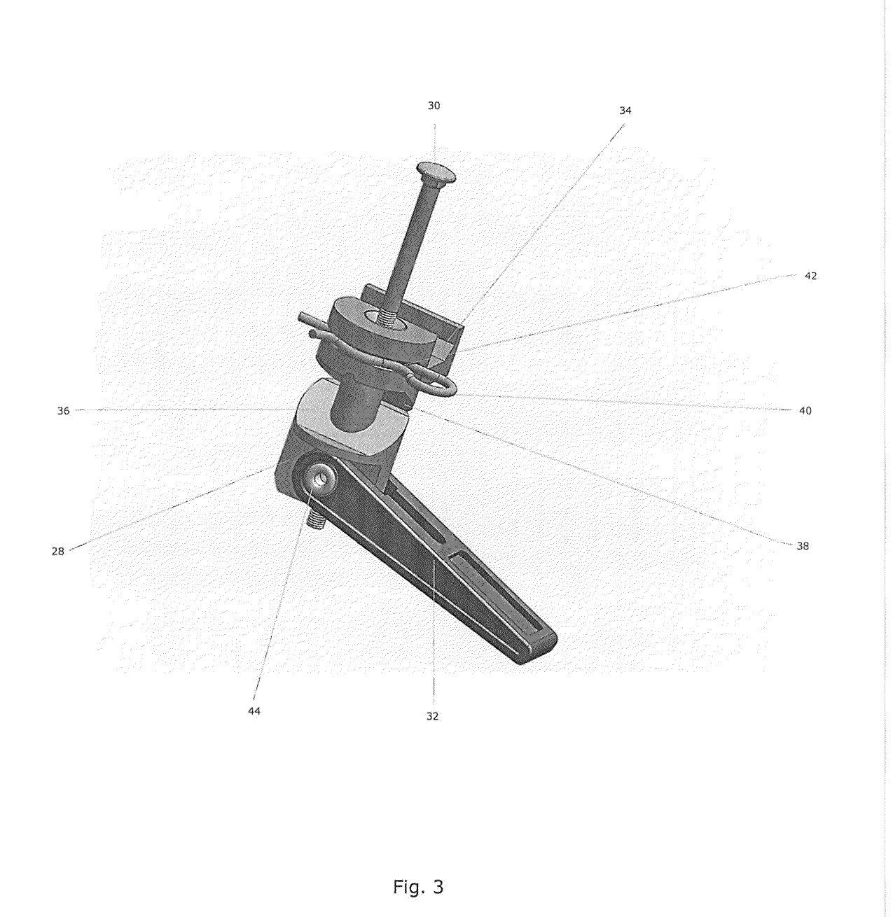

In reference to FIG. 3 and accordingly in the interest of brevity, only one clamp coupling 28 will be discussed in detail below unless noted other-wise. Therefore clamp system 28 attaches and suspends via an adjustable rod 30 having adjustability from inside a hollowed section of the tonneau longitudinal frame work. Clamping system 28 consist of a handle 32 having lateral and rotation movement which allows appropriate leverage to increase or decrease coupling tension between the tonneau cover frame system and cargo bed 4. Clamp mating surface 36 is intergraded as part of rotating handle 32 which when rotated either clockwise or counter clockwise, creates an increase or decrease in elevation in clamp mating surface 36 against clamp mating surface 38. Integrated as part of clamp mating surface 38 is lip receiver slot 34, designed to engage in the overhanging, lip surface 22, which was provided for by cargo bed construction installing frame bracketing a long the lip surface wall 24 which will then receive clamp receiver slot 34. Select tensioning between receiver slot 34 and the cargo bed lip 22 is achieved during handle 32 rotations and when the two diagonal mating surfaces 36 and 38 increasing in elevation creating lifting separation between the two mating surfaces. Once desired tensioning has been achieved, a removable locking pin 40 is inserted into provisional slot and hole 42 which secures the clamp in place and preventing coupling tension loss. Pivot point 44 allows handle 32 folding flexibility, thus providing less exposure for damage or detensioning due to stowed cargo shifting.

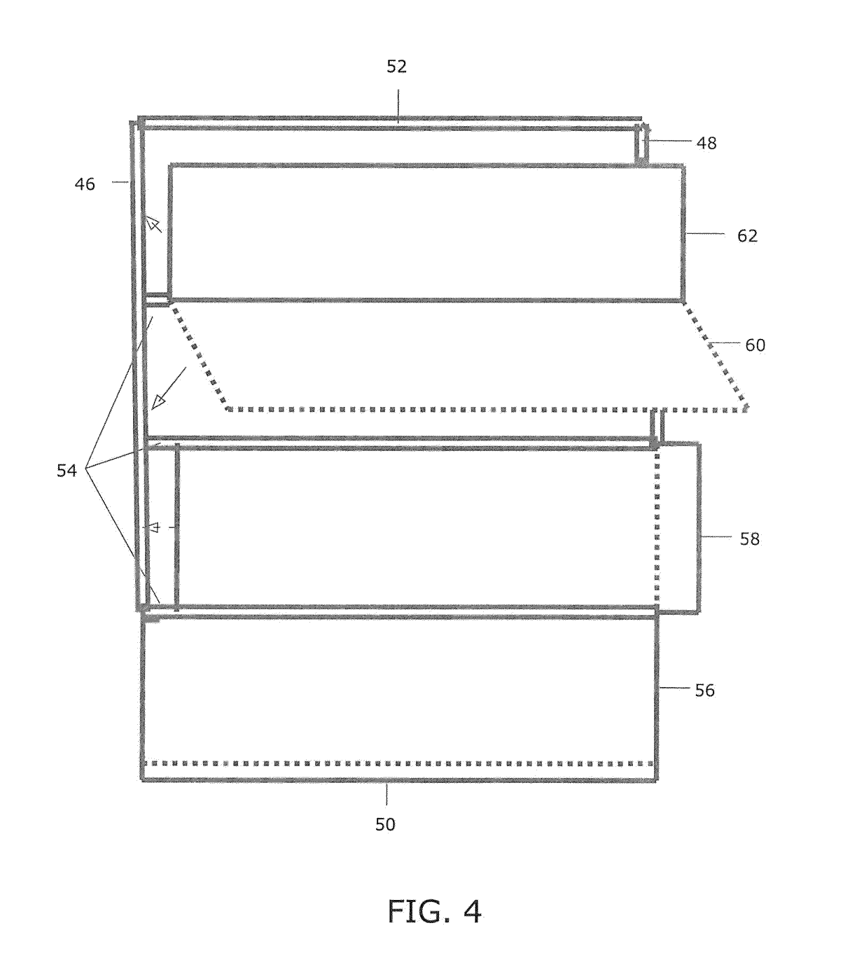

In reference to FIG. 4 a tonneau cover system includes an internal framework having a right frame rail 48, a left frame rail 46, a front frame rail 50, a rear frame rail 52 and a series of cross support rails 54. This internal frame work mirrors the symmetry of the cargo bed walls which pertains to a specific vehicle make and model. A weather resistant solid one piece cover 56 spans the length and width of the internal frame work assembly. A, fixed in place soft or hard cover 56, attaches to the internal framework and is typically hinged to the cargo bed by rear frame rail 52. Clamping assemblies are located at the opposite end and on frame rail 52 and when open, allows easy access to the cargo bed or to stowed cargo.

A tonneau cover system as illustrated by item 58 provides one or more detachable sections held in place by a series of clamping assemblies. Uncoupling of the clamp assemblies from the cargo bed or other detachable sections allows one or more removal sections of the weather resistance covering, thus providing access to the cargo bed or to stowed cargo.

A tonneau cover system illustrated as item 60 provides individual hinged sections of the weather resistance covering. Any number of hinged sections include a series of clamping assemblies which when uncoupled, allows one or more individual sections to open, thus providing access to the cargo bed or to stowed cargo. When a series of hinged sections 60 are combined, they form the weather resistance cover.

Accordingly, the spirit and scope of the present invention is limited only by the terms of the following claims.

1.-4. (canceled)

5. A combination of a tonneau cover system for the cargo bed of a pickup truck and a clamp assembly to hold the tonneau cover system to the bed, the combination comprising:
a tonneau cover system comprising an internal framework, the framework comprising at least a right frame rail and a left frame rail, a front frame rail and a rear frame rail; the system further comprising a weather resistant cover that spans the length and distance of the framework; and,
at least one clamping assembly, the clamping assembly comprising an adjustable rod, a foldable and rotatable handle having integration to a first clamping element, wherein the first clamping element comprises a first diagonal clamping surface, a second clamping element, wherein the second clamping element comprises a second diagonal clamping surface, the first and the second clamping elements being relatively moveable towards or away from each other by rotation of the handle.

6. The combination of claim 5, wherein the adjustable rod is threaded.

7. The combination of claim 6, wherein rotation of the handle moves the handle on the threads of said rod.

8. The combination of claim 5, wherein the framework additionally comprises at least one cross support sub rail, wherein the sub rail is connected to the right frame rail and the left frame rail.

9. The combination of claim 8, comprising a plurality of cross support sub rails and each of said sub rails are connected to the right frame rail and the left frame rail.

10. The combination of claim 5, wherein the adjustable rod is threaded, and the rod is suspended from at least one of the right side rail or the left side rail.

11. The combination of claim 10, wherein the second clamping element further comprises a receiver slot, wherein, said receiver slot is sized and shaped to engage an edge of an overhanging lip of the cargo bed of the pick-up truck.

12. The combination of claim 11, further comprising a pin insertable into a slot in the second clamping element.

13. The combination of claim 5, wherein the first and second diagonal clamping surfaces face each other.

14. The combination of claim 5, wherein the weather resistant cover is a hard cover.

15. The combination of claim 5, wherein the weather resistant cover is a soft cover.

16. The combination of claim 9, wherein the weather resistant cover comprises a plurality of sections, at least two of said sections being hingedly connected to each other.

17. The combination of claim 5, wherein the weather resistant cover comprises a one piece cover.
